(19) United States
(12) Patent Application Publication
(10) Pub. No.: US 2003/0033602 A1
(43) Pub. Date: Feb. 13, 2003

(54) Method and apparatus for automatic tagging and caching of highlights

(76) Inventors: Simon Gibbs, San Jose, CA (US); Sidney Wang, Pleasanton, CA (US)

Correspondence Address: Valley Oak Law, 5655 Silver Creek Valley Road, #106, San Jose, CA, 95138, US

(21) Appl. No.: 10/108,853

(22) Filed: Mar. 27, 2002

Related U.S. Application Data
(60) Provisional application No. 60/311,071, filed on Aug. 8, 2001.

(51) Int. Cl. H04N 5/445; G06F 3/00; G06F 13/00

(52) U.S. Cl. 725/46

(57) ABSTRACT

The invention illustrates a system and method for recording an event comprising: a recording device for capturing a sequence of images of the event; sensing device for capturing a sequence of sensory data of the event; and a synchronizer device connected to the recording device and the sensing device for formatting the sequence of images and the sequence of sensory data into a correlated data stream wherein a portion of the sequence of images corresponds to a portion of the sequence of sensory data.

### CROSS REFERENCE TO RELATED APPLICATIONS

The present application claims benefit of U.S. Provisional Patent Application No. 60/311,071, filed on Aug. 8, 2001, entitled “Automatic Tagging and Caching of Highlights” listing the same inventors, the disclosure of which is hereby incorporated by reference.

### FIELD OF THE INVENTION

The invention relates generally to the field of audio/visual content, and more particularly correlating sensory data with the audio/visual content.

### BACKGROUND OF THE INVENTION

Being able to record audio/visual programming allows viewers greater flexibility in viewing, storing and distributing audio/visual programming. Viewers are able to record and view video programs through a computer, video cassette recorder, digital video disc recorder, and digital video recorder. With modern storage technology, viewers are able to store vast amounts of audio/visual programming. However, attempting to locate and view stored audio/visual programming often relies on accurate, systematic labeling of different audio/visual programs. Further, it is often time consuming to search through numerous computer files or video cassettes to find a specific audio/visual program.

Even when the correct audio/visual programming is found, viewers may want to view only a specific portion of the audio/visual programming. For example, a viewer may wish to see only highlights of a golf game such as player putting on the green instead of an entire golf tournament. Searching for specific events within a video program would be a beneficial feature.

Without an automated search mechanism, the viewer would typically fast forward through the program while carefully scanning for specific events. Manually searching for specific events within a program can be inaccurate and time consuming.

Searching the video program by image recognition and metadata are methods of identifying specific segments within a video program. However, image recognition relies on identifying a specific image to identify the specific segments of interest. Unfortunately, many scenes within the entire video program may have similarities which prevent the image recognition from identifying the specific segments of interest from the entire video program. On the other hand, the target characteristics of the specific image may be too narrow to identify any of the specific segments of interest.

Utilizing metadata to search for the specific segments of interest within the video program relies on the existence of metadata corresponding to the video program and describing specific segments of the video program. The creation of metadata describing specific segments within the video program is typically a labor-intensive task. Further, the terminology utilized in creating the metadata describing specific segments is subjective, inexact and reliant on interpretation.

### SUMMARY OF THE INVENTION

The invention illustrates a system and method for recording an event comprising: a recording device for capturing a sequence of images of the event; sensing device for capturing a sequence of sensory data of the event; and a synchronizer device connected to the recording device and the sensing device for formatting the sequence of images and the sequence of sensory data into a correlated data stream wherein a portion of the sequence of images corresponds to a portion of the sequence of sensory data.

Other aspects and advantages of the invention will become apparent from the following detailed description, taken in conjunction with the accompanying drawings, illustrated by way of example of the principles of the invention.

### BRIEF DESCRIPTION OF THE DRAWINGS

FIG. 1 illustrates one embodiment of an audio/visual production system according to the invention.

FIG. 2 illustrates an exemplary audio/visual content stream according to the invention.

FIG. 3 illustrates one embodiment of an audio/visual output system according to the invention.

FIG. 4 illustrates examples of sensory data utilizing an auto racing application according to the invention.

FIG. 5A illustrates examples of sensory data utilizing a football application according to the invention.

FIG. 5B illustrates examples of sensory data utilizing a hockey application according to the invention.

### DETAILED DESCRIPTION

Specific reference is made in detail to the embodiments of the invention, examples of which are illustrated in the accompanying drawings. While the invention is described in conjunction with the embodiments, it will be understood that the embodiments are not intended to limit the scope of the invention. The various embodiments are intended to illustrate the invention in different applications. Further, specific details are set forth in the embodiments for exemplary purposes and are not intended to limit the scope of the invention. In other instances, well-known methods, procedures, and components have not been described in detail as not to unnecessarily obscure aspects of the invention.

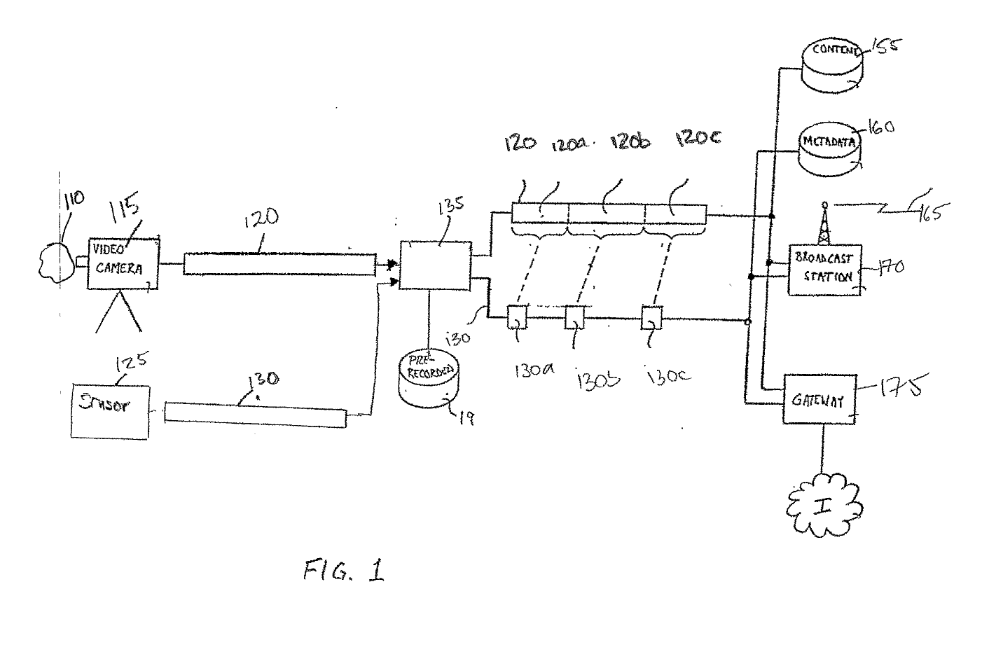

FIG. 1 illustrates the production end of a simplified audio/visual system. A video camera 115 produces a signal containing an audio/visual data stream 120 that includes images of an event 110. The audio/visual recording device in one embodiment includes the video camera 115. The event 110 may include sporting events, political events, conferences, concerts, and other events which are recorded live. The audio/visual data stream 120 is routed to a tag generator 135. A sensor 125 produces a signal containing a sensory data stream 130. The sensor 125 observes physical attributes of the event 110 to produce the sensory data stream 130. The physical attributes include location information, forces applied on a subject, velocity of a subject, and the like; these physical attributes are represented in the sensory data stream 130. The sensory data stream 130 is routed to the tag generator 135.

The tag generator 135 analyzes the audio/visual data stream 120 to identify segments within the audio/visual data stream 120. For example, if the event 110 is an automobile race, the idea/visual data stream 120 contains video images of content segments such ads to raise start, it stops, lead changes, and crashes. These content segments are identified in the tag generator 135. Persons familiar with video production will understand that such a near—real-time classification task is analogous to identifying start and stop points in audio/visual instant replay are the recording an athlete's actions by sports statisticians. A particularly useful and desirable attribute of this classification is the fine granularity of the tagged content segments, which in some instances is on the order of one second or less or even a single audio/visual frame. Thus, an audio/visual segments such as segment 120a may contain a very short video clip showing for example a single car pass made by a particular race car driver. Alternatively, the audio/visual segment may have a longer duration of several minutes or more.

Once the tag generator 135 divides the audio/visual data stream 120 into segments such as segment 120a, segment 120b, and segment 120c, the tag generator 135 processes the sensory data stream 130. The tag generator 135 divides the sensory data stream 130 into segment 130a, segments 130b, and segment 130c. The sensory data stream 130 is divided by the tag generator 135 based upon the segments 120a, 120b, 120c found in the audio/visual data stream 120. The portion of the sensory data stream 130 which is within the segments 130a, 130b, and 130c correspond with the portion of the audio/visual data stream 120 within the segments 120a, 120b, and 120c, respectively. The tag generator 135 synchronizes the sensory data stream 130 such that the segments 130a, 130b, and 130c correspond with the segments 120a, 120b, and 130c, respectively. For example, a particular segment within the audio/visual data stream 120 may show images related to a car crash. A corresponding segment of the sensory data stream 130 contains data from a sensor 125 observing physical attributes of the car crash such as the location of the car and forces experienced by the car during the car crash. In some embodiments, the sensory data stream 130 is separate from the audio/visual data stream 120, while in other embodiments the sensory data stream 130 and audio/visual data stream 120 are multiplexed together.

In one embodiment, the tag generator 135 initially divides the audio/visual data stream 120 into individual segments and subsequently divides the sensory data stream 130 into individual segments which correspond to the segments of the audio/visual data stream 120. In another embodiment, the tag generator 135 initially divides the sensory data stream 130 into individual segments and subsequently divides the audio/visual data stream 120 into individual segments which correspond to the segments of the sensory data stream 130.

In order to determine where to divide the audio/visual data stream 120 into individual segments, the tag generator 135 considers various factors such as changes between adjacent images, changes over a group of images, and length of time between segments. In order to determine where to divide the sensory data stream 130 into individual segments, the tag generator 135 considers various factors such as change in recorded data over any period of time and the like.

In various embodiments the audio/visual data stream 120 is routed in various ways after that tag generator 135. In one instance, the images in the audio/visual data stream 120 are stored in a content database 155. In another instance, the audio/visual data stream 120 is routed to commercial television broadcast stations 170 for conventional broadcast. In yet another instance, the audio/visual data stream 120 is routed to a conventional Internet gateway 175. Similarly, in various embodiments, the sensory data within the sensory data stream 130 is stored into sensory database 160, broadcast through the transmitter 117, or broadcast through the Internet gateway 175. These content and sensory data examples are illustrative and are not limiting. For example the databases 155 and 160 may be combined into a single database, but are shown as separate elements in FIG. 1 for clarity. Other transmission media may be used for transmitting audio/visual and/or sensory data. Thus, sensory data may be transmitted at a different time, and to be at a different transmission medium, than the audio/visual data.

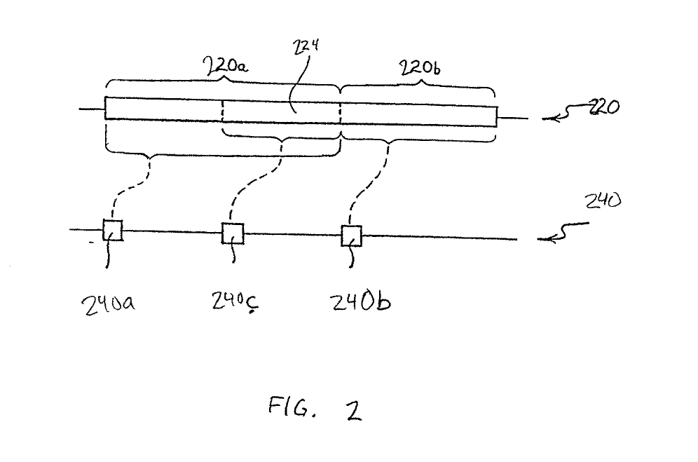

FIG. 2 shows an audio/visual data stream 220 that contains audio/visual images that have been processed by the tag generator 135 (FIG. 1.) A sensory data stream 240 contains the sensory data associated with segments and sub segments of the audio/visual data stream 220. The audio/visual data stream 220 is classified into two content segments (segment 220a and segment 220b.) An audio/visual sub segment 224 within the segment 220a has also been identified. The sensory data stream 240 includes sensory data 240a that is associated with the segment 220a, sensory data 240b that is associated with the segment 220b, and sensory data 220c data associated with sub segment 224. The above examples are shown only to illustrate different possible granularity levels of sensory data. In one embodiment the use of multiple granularity levels of sensory data is utilized identify and specific portion of the audio/visual data.

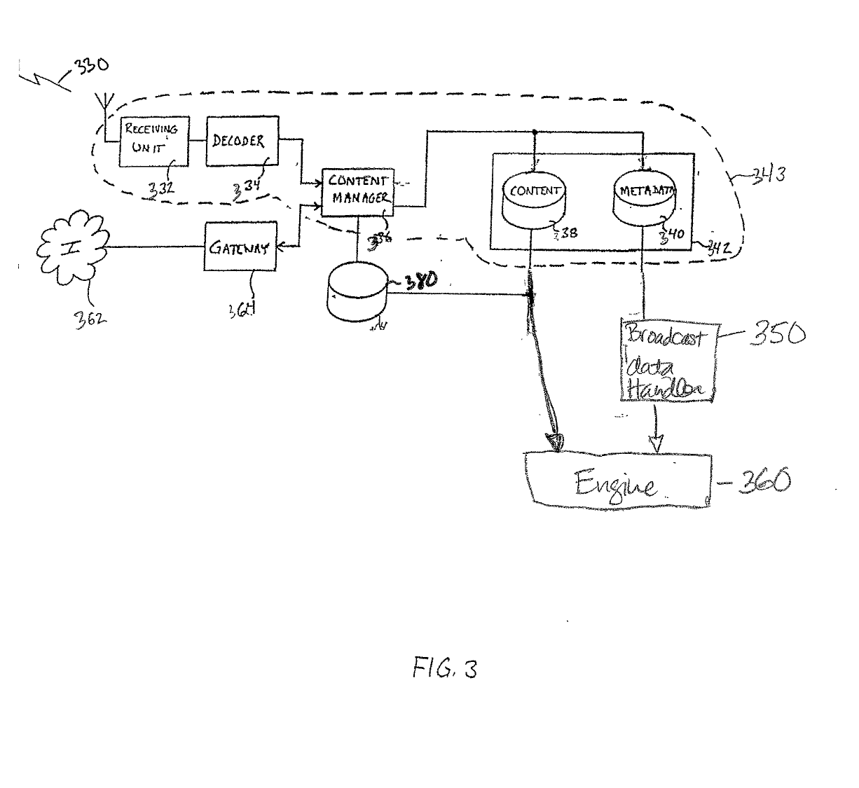

FIG. 3 is a view illustrating an embodiment of the video processing and output components at the client. Audio/visual content and sensory data are initiated with the video content and contained in signal 330. Conventional receiving unit 332 captures the signal 330 and outputs the captured signal to conventional decoder unit 334 that codes the audio/visual content and sensory data. The decoded audio/visual content and sensory data from the unit 334 are output to content manager 336 that routes the audio/visual content to content storage unit 338 and the sensory data to the sensory data storage unit 340. The storage units 338 and 340 are shown separately to more clearly describe the invention, but in some embodiments units 338 and 340 are shown separately to more clearly describe the invention, but in some embodiments units 338 and 340 are combined as a single local media cache memory unit 342. In some embodiments, the receiving unit 332, the decoder 334, the content manager 336, and the cache 342 are included in a single audiovisual combination unit 343.

In some embodiments the audio/visual content and/or sensory data to be stored in the cache 342 is received from a source other than the signal 330. For example, the sensory data may be received from the Internet 362 through the conventional Internet gateway 364. In some embodiments, the content manager 336 actively accesses audio/visual content and/or sensory data from the Internet and subsequently downloads the access to material into the cache 342.

It is not required that all segments of live or prerecorded audio/visual content be tagged. Only those data segments that have specific predetermined attributes are tagged. The sensory data formats are structured in various ways to accommodate the various action rates associated with particular televised live events or prerecorded production shows. The following examples are illustrative and skilled artisans will understand that many variations exist. In pseudocode, a sensory data may have the following format:

Sensory data {

Type
Video ID
Start Time
Duration
Category

Content #1
Content #2

Pointer
}

In this illustrative format, “Sensory Data” identifies the following information within the following braces as sensory data. “Type” identifies the sensory data type such as location data, force data, acceleration data, and the like. “Video ID” uniquely identifies the portion of the audio/visual content. “Start Time” relates to the universal time code which corresponds to the original airtime of the audio/visual content. “Duration” is the Time duration of the video content associated with the sensory data tag. “Category” defines a major subject category such as pit stops, crashes, and spin outs. “Content #1” and “Content #2” identifies additional layered attribute information such as driver name within that “category” classification. “Pointer” is a pointer to a relevant still image that is output to the viewer. The still image represents the audio/visual content of the tagged audio/visual portion such as spin-outs or crash. The still image is used in some embodiments as part of the intuitive interface presented on output unit 356 that as described below.

Viewer preferences are stored in the preferences database 380. These preferences identify topics have specific interest to the viewer. In various embodiments the preferences are based on the viewer's viewing history or habits, direct input by the viewer, and predetermined or suggested input from outside the client location.

The fine granularity at tagged audio/visual segments and associated sensory data allows the presentation engine 360 to output many possible customized presentations or programs to the viewer. Illustrated embodiments of such customized presentations or programs are discussed below.

Some embodiments of customized program output 358 are virtual television programs. For example, audio/visual segments from one or more programs are received by the content manager 336, combined and outputted to the viewer as a new program. These audio/visual segments are accumulated over a period of time, and some cases on the order of seconds and in other cases as long as a year or more. For example, useful accumulation periods are one day, one week, and one month, thereby allowing the viewer to watch and daily weekly or monthly virtual program of particular interests. Further, the content audio/visual segments used in the new program can be from programs received on different channels. One result of creating such a customize output is that content originally broadcast for one purpose can be combined and output for different purpose. Thus the new program is adapted to the viewer's personal preferences. The same programs are therefore received a different client locations, but each viewer at each client locations sees a unique program that is native segments of the received programs and his customized to conform with each viewer's particular interests.

Another embodiment of the program output 358 is a condensed version of a conventional program that enables the viewer to view highlights of the conventional program. During situations in which the viewer tunes to the conventional program after their program has begun, the condensed version is a summary of preceding highlights. This summary allows the viewer to catch up with the conventional program in progress. Such a summary can be used, for example, for live sports events or prerecorded content such as documentaries. The availability of a summary encourages the viewer to tune and continue watching the conventional program even if the viewer has missed an earlier portion of the program. Another situation, the condensed version is used to receive particular highlights of the completed conventional program without waiting for a commercially produced highlight program. For example, the viewer of a baseball game views a condensed version that shows, for example, game highlights, highlights of the second player, or highlights from two or more baseball games.

Another embodiment, the condensed presentation is tailored to an individual viewer's preferences by using the associated sensory data to filter the desired event portion categories in accordance with the viewer's preferences. The viewer's preferences are stored as a list of filter attributes in the preferences memory 380. The content manager compares attributes in received sensory data with the attributes in the filter attribute list. If the received sensory data attribute matches a filter attribute, the audio/visual content segment that is associated with the sensory data is stored in the local cache and 342. Using the car racing example, one viewer may wish to see pit stops and crashes, while another viewer may wish to see only content that is associated with particular driver throughout the race. As another example, a parental rating is associated with video content portions to ensure that some video segments are not locally recorded.

The capacity to produce virtual or condensed program output also promotes content storage efficiency. If the viewer's preferences are to see only particular audio/visual segments, only those particular audio/visual segments are stored in the cache 342. As result, storage efficiency is increased and allows audio/visual content that is of particular interest to the viewer to be stored in the cache 342. The sensory data enables the local content manager 336 to locally store video content more efficiently since the condensed presentation is not require other segments of the video program to be stored for output to the viewer. Car races, for instance, typically contain times when no significant activity occurs. Interesting events such as pit stops, crashes, and lead changes occur only intermittently. Between these interesting events, however, little occurs as a particular interest to the average race viewer.

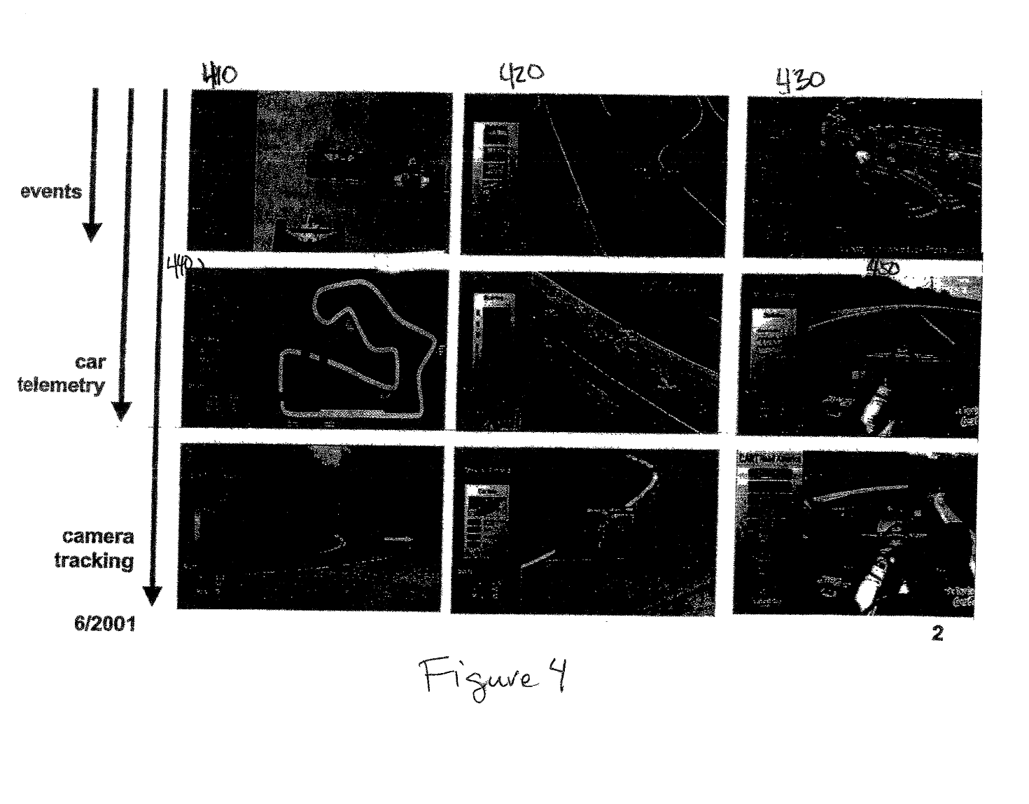

FIG. 4 illustrates exemplary forms of sensory data within the context of an auto racing application. Screenshot 410 illustrates use of positional data to determine the progress of the individual cars relative to each other, relative to their location on the track, and relative to the duration of the race. Screenshot 420 illustrates use of positional data to detect a car leaving the boundaries of the paved roadway as well as force data indicating changes in movements of the car such as slowing down rapidly. Screenshot 430 illustrates use of positional data to detect a car being serviced in the pit during a stop. Screenshot 440 illustrates use of positional data to determine the order of the cars and their locations on the race track. Screenshot 450 illustrates use of force data to show the accelerative forces being applied to the car and felt by the driver. In practice, sensory data is generally collected by a number of various specialized sensors. For example, to track the positional data of the cars, tracking sensors can be placed on the cars and radio waves from towers in different locations can triangulate the position of the car. Other embodiments to obtain positional data may utilize global positioning systems (GPS). To track the force data of the cars, accelerometers can be installed within each car and instantaneously communicate the forces via radio frequencies to a base unit.

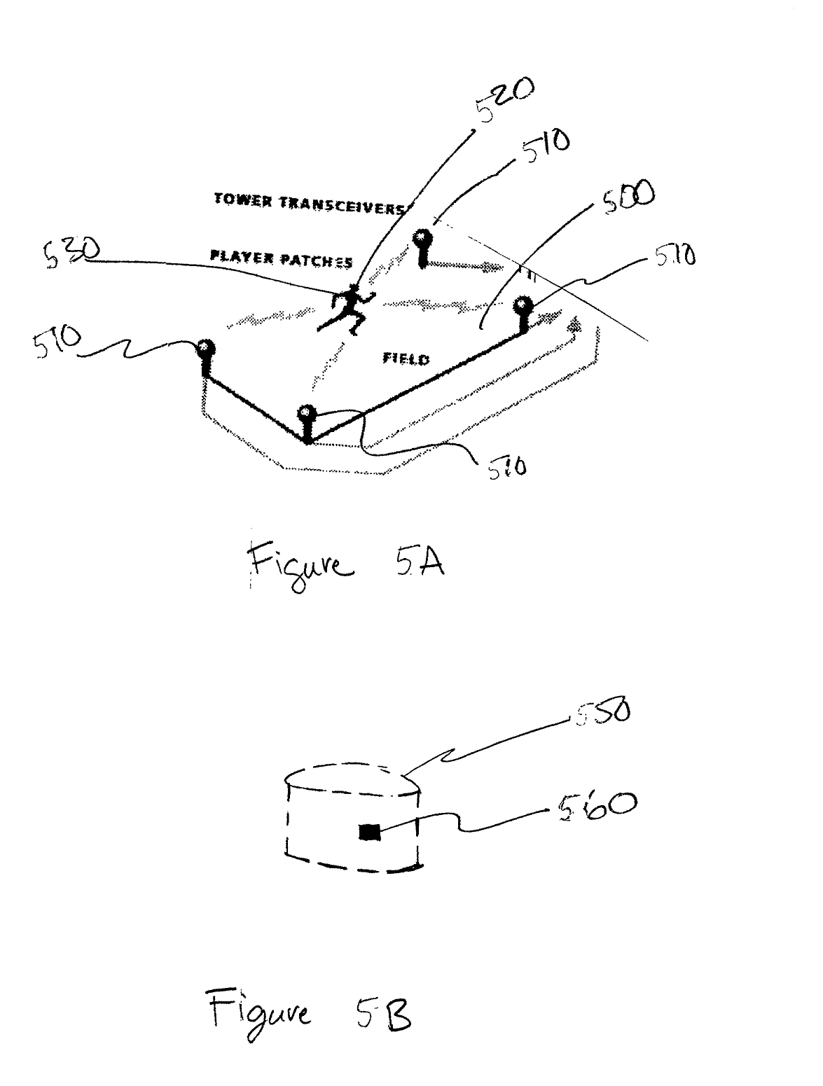

FIG. 5A illustrates exemplary forms of sensory data within the context of a football application. A playing field 500 is surrounded by a plurality of transceiver towers 510. The playing field 500 is configured as a conventional football field and allows a plurality of players to utilize the field. An exemplary football player 520 is shown on the playing field 500. The football player 520 is wearing a sensor 530. The sensor 530 captures positional data of the football player 520 as the player traverses the playing field 500. The sensor 530 is in communication with the plurality of transceiver towers 510 via radio frequency. The plurality of transceiver towers 510 track the location of the sensor 530 and are capable of pinpointing the location of the sensor 530 and the football player 520 on the playing field 500. In another embodiment, the coverage of the plurality of transceivers 510 is not limited to the playing field 500. Further, tracking the location of multiple players is possible. In addition to the sensor 530 for tracking the location of the player, force sensors can be utilized on the player to measure impact forces and player acceleration.

FIG. 5B illustrates exemplary forms of sensory data within the context of a hockey application. A hockey puck 550 is shown with a sensor 560 residing within the hockey puck 550. The sensor 560 is configured generate sensory data indicating the location of and the accelerative forces on the hockey puck 550. Additionally, the sensory 560 transmits this sensory data relative to the hockey puck 650 to a remote device.

The foregoing descriptions of specific embodiments of the invention have been presented for purposes of illustration and description. For example, the invention is described within the context of auto racing and football as merely embodiments of the invention. The invention may be applied to a variety of other theatrical, musical, game show, reality show, and sports productions. They are not intended to be exhaustive or to limit the invention to the precise embodiments disclosed, and naturally many modifications and variations are possible in light of the above teaching. The embodiments were chosen and described in order to explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

In the Claims:

1. A method of using sensory data corresponding with content data comprising:
a. recording the content data through a recording device;
b. simultaneously capturing the sensory data through a sensor while recording the content; and
c. relating a portion of the sensory data corresponding to a portion of the content data.

2. The method according to claim 1 further comprising storing a user preference.

3. The method according to claim 2 further comprising searching the sensory data in response to the user preference.

4. The method according to claim 2 further comprising storing the portion of the content data in response to the user preference.

5. The method according to claim 1 further comprising tagging the portion of the content data in response to the portion of the sensory data.

6. The method according to claim 1 further comprising generating the sensory data via the sensor.

7. The method according to claim 1 wherein the sensory data includes positional data.

8. The method according to claim 1 wherein the sensory data includes force data.

9. The method according to claim 1 wherein the content data includes audio/visual data.

10. The method according to claim 1 wherein the recording device includes a audio/visual camera.

11. The method according to claim 1 wherein the sensor is an accelerometer.

12. A method of recording an event comprising:
a. capturing an audio/visual data stream of the event through a recording device;
b. capturing a sensory data stream of the event through a sensing device; and
c. synchronizing the audio/visual data stream and the sensory data stream such that a portion of the sensory data stream corresponds with a portion of the audio/visual data stream.

13. The method according to claim 12 further comprising storing a user preference describing a viewing desire of a user.

14. The method according to claim 13 further comprising highlighting a portion of the audio/visual data stream based on the user preference.

15. The method according to claim 12 further comprising analyzing the sensory data stream for specific parameters.

16. The method according to claim 15 further comprising highlighting the portion of the audio/visual data stream based on analyzing the sensory data stream.

17. The method according to claim 12 wherein the sensory data stream describes the scene using location data of subjects within the event.

18. The method according to claim 12 wherein the sensory data stream describe the scene using force data of subjects within the event.

19. A system for recording an event comprising:
a. a recording device for capturing a sequence of images of the event;
b. sensing device for capturing a sequence of sensory data of the event; and
c. a synchronizer device connected to the recording device and the sensing device for formatting the sequence of images and the sequence of sensory data into a correlated data stream wherein a portion of the sequence of images corresponds to a portion of the sequence of sensory data.

20. The system according to claim 20 further comprising a storage device connected to the recording device and the sensing means for storing the plurality of images and the plurality of sensory data.

21. The system according to claim 20 further comprising a storage device connected to the synchronizer device for storing the correlated data stream.

22. The system according to claim 20 wherein the sensing device is an accelerometer.

23. The system according to claim 20 wherein the sensing device is a location transponder.

24. The system according to claim 20 wherein the sensing device is force sensor.

25. The system according to claim 20 wherein the recording device is a video camera.

26. The system according to claim 20 wherein the plurality of sensory data includes positional data.

27. The system according to claim 20 wherein the plurality of sensory data includes force data.

28. A computer-readable medium having computer executable instructions for performing a method comprising:
a. recording the content data through a recording device;
b. simultaneously capturing the sensory data through a sensor while recording the content; and
c. relating a portion of the sensory data corresponding to a portion of the content data.
